(19) United States
(12) Patent Application Publication
(10) Pub. No.: US 2019/0184960 A1
(43) Pub. Date: Jun. 20, 2019

(54) METHOD FOR OPERATING A DRIVE TRAIN OF A MOTOR VEHICLE

(71) Applicant: ZF Friedrichshafen AG, Friedrichshafen (DE)

(72) Inventor: Michael GIERLING, Langenargen (DE)

(21) Appl. No.: 16/218,523

(22) Filed: Dec. 13, 2018

(30) Foreign Application Priority Data
Dec. 15, 2017 (DE) 10 2017 222 928.4

(51) Int. Cl. B60W 10/06; B60W 10/184; B60W 30/18; B60W 10/08; B60W 30/14

(52) U.S. Cl. CPC B60W 10/06; B60W 10/184; B60W 30/18072; B60W 2710/182; B60W 30/143; B60W 30/18109; B60W 10/08

(57) ABSTRACT

A method for operating a drive-train (1) of a motor vehicle. The drive-train (1) has an internal combustion engine, a transmission connected between the internal combustion engine and a drive output, and a compressed air system of a brake unit. While the motor vehicle is travelling, if a manual command is issued or if defined operating conditions are satisfied, the drive-train (1) is operated in a coasting mode in which the drive-train (1) is disengaged and the internal combustion engine is turned off. During the coasting mode, a pressure in a compressed air system of the brake unit is determined, and if the determined pressure reaches or falls below a predefined first pressure value, the pressure in the compressed air system of the brake unit is automatically increased, via a pressure-generator, to a predefined second pressure value.

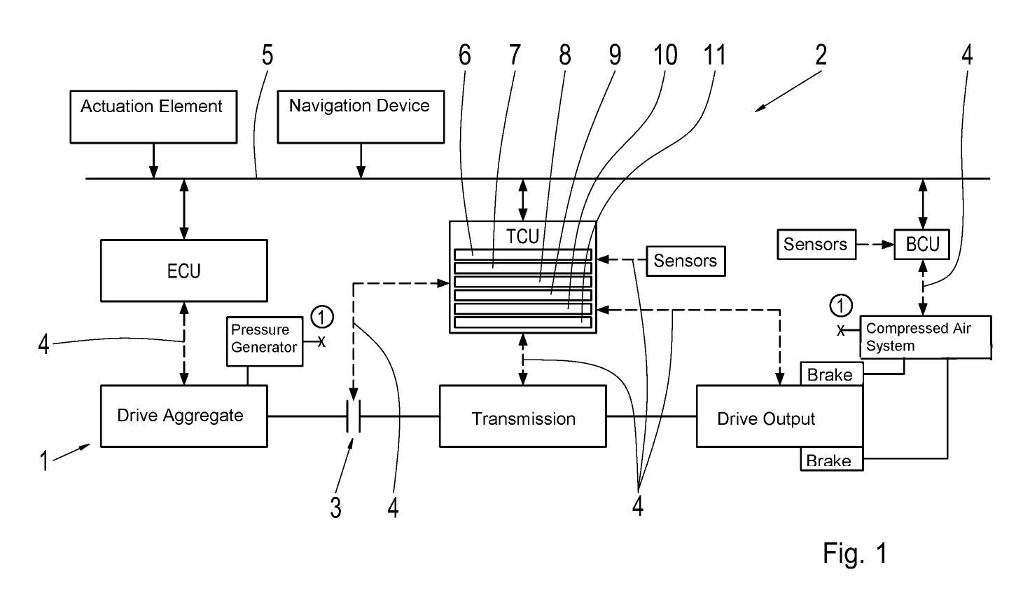

This application claims priority from German patent application serial no. 10 2017 222 928.4 filed Dec. 15, 2017.

### FIELD OF THE INVENTION

The invention relates to a method for operating a drive-train of a motor vehicle. The invention also relates to a control unit for carrying out the method, and to a corresponding computer program product.

### BACKGROUND OF THE INVENTION

In general, it is an aspiration of the development of new motor vehicles and the further development of existing motor vehicles. In particular commercial vehicles, to reduce fuel consumption and the emissions of harmful substances and CO₂. Besides the technical optimization of motor vehicles, such as the development of low-consumption and low-emission drive motors, efficiency-optimized multi-stage manual transmissions, tires with low rolling resistance, and streamlined vehicle bodies, truck drivers' cabins and truck bodies, a further possibility for reducing fuel consumption and the emissions of harmful substances and CO₂ is to use the motor vehicle with appropriate control of the driving operation.

To save energy and costs and to reduce the burden on the environment, in suitable driving situations vehicles can temporarily continue moving ahead without drive-power, in so-termed rolling or coasting mode. In particular, in a motor vehicle in the rolling mode the internal combustion engine can be operated with as low consumption and emissions as possible by idling, while the vehicle is rolling with its drive-train open. If the internal combustion engine is switched off in such a driving situation in order to increase the savings effect still more, the vehicle moves in a so-termed coasting mode. These functions are already known.

Depending on the drive-train components present and the existing type of transmission, the power flow can be interrupted by shifting the transmission to neutral or by opening a starting clutch, as soon as a rolling mode or coasting mode is deemed possible.

It is known that motor vehicles can be equipped with a compressed air system with which various pneumatic components of the motor vehicle can be operated. Particularly in the case of commercial vehicles, for example, a compressed air system can be used to actuate a compressed-air brake unit of the commercial vehicle. To supply the compressed air system with compressed air, the vehicle has an air compressor which is usually permanently in driving connection with a combustion engine of the motor vehicle.

WO 2016/007071 A1 describes a method for controlling an internal combustion engine of a motor vehicle. Having regard to a future speed profile, it is established by simulation whether the motor vehicle can be operated in a coasting mode. Before the motor vehicle is operated in the coasting mode, various conditions are checked, which must be satisfied in order to authorize the internal combustion engine to be switched off. One of these conditions is a pressure for a service brake of the motor vehicle, such that if the pressure falls below a specified value the switching off of the internal combustion engine is prevented.

### SUMMARY OF THE INVENTION

The purpose of the present invention is to provide a new type of method for operating a drive-train of a motor vehicle. In addition a control unit designed to carry out the method and a computer program product for carrying out the method are to be indicated.

From the process-technological standpoint this objective is achieved, starting from the preamble of the independent claims, in combination with its characterizing features. A control unit for operating a drive-train of a motor vehicle is also the object of the independent claims. As for a computer program product, reference is made to the independent claims. Advantageous further developments are the object of the subordinate claims and of the description that follows.

A method for operating a drive-train of a motor vehicle is proposed, wherein the drive-train comprises an internal combustion engine, a drive output, a transmission connected between the internal combustion engine and the drive output, and a compressed air system for a pneumatic brake assembly.

The motor vehicle can be a commercial vehicle such as a truck or a bus.

In this case the transmission is in particular a multi-gear transmission in which a plurality of transmission ratio steps, i.e. fixed gear ratios between two shafts of the transmission, can be engaged by shifting elements, preferably in an automated manner. The shifting elements can be interlocking or frictional shifting elements. Such transmissions are used in motor vehicles, especially commercial vehicles, in order to suitably adapt the rotational speed and torque output characteristic of the drive unit to the driving resistances of the vehicle. By appropriate control of the shifting elements the transmission can be brought to a neutral position, in which the internal combustion engine is disconnected from the drive output.

It is provided that during the driving of the vehicle, if a manual command is issued or if defined operating conditions exist the drive-train is operated in a coasting mode in which the drivetrain is opened and, to produce the coasting mode, the internal combustion engine is switched off.

The manual command for the coasting mode can for example be made by a vehicle driver by manually actuating an appropriate operating element. The operating element can for example be in the form of a key or switch arranged on the instrument panel of the motor vehicle.

Before the motor vehicle is operated automatically in the coasting mode various operating conditions are checked, which have to be satisfied in order to authorize opening the drive-train and switching off the internal combustion engine, For example, the operating conditions that must be satisfied for coasting operation include a current travel speed higher than a defined minimum speed, the absence of an acceleration demand, the absence of a deceleration demand, and if necessary also a current road gradient between a permissible maximum downhill inclination and a permissible maximum uphill slope.

For example, there is no acceleration demand if an accelerator pedal is not actuated or there is no engine torque demand from an active cruise control, whereas for example there is no deceleration demand if a brake pedal is not actuated or there is no braking torque demand from an active cruise control.

As a further operation condition for the initiation of the coasting mode, while driving with the drive-train closed a speed variation forecast for a road section ahead when the power flow in the drive-Strain is interrupted, is determined. For this, in a manner known as such, a road gradient variation or a driving resistance profile for the road section ahead can be determined from elevation data taken from a topographical map. From the road gradient variation or driving resistance profile, and taking account of the current travel speed, the mass of the vehicle, the rolling resistance and the air resistance of the vehicle the speed variation when the power flow is interrupted can be determined and, depending on the speed variation determined, the coasting mode can be authorized or blocked. The topographical map can be stored, for example, in a transmission control unit of the transmission or in a navigation unit of the motor vehicle.

As an operating condition for the authorization of the coasting mode, the pressure in a brake unit of the motor vehicle can also be taken into account, in such manner that if the pressure falls below a specified value, switching off of the internal combustion engine in the context of the coasting mode is prevented.

The invention now is based on the technical principle that when the drive-train is operated in a coasting mode, a pressure in the compressed air system of the brake unit is determined and compared with a predefined first pressure value, if the pressure in the compressed air system of the brake unit is equal to or lower than the predefined first pressure value, then the pressure in the compressed air system of the brake unit is automatically topped up by a pressure-generator to a predefined, second pressure value.

In other words, while the drive-train is operating in the coasting mode with the internal combustion engine switched off, a pressure in the compressed air system of the brake unit is monitored and if the pressure is at or below a predefined minimum value, a pressure-generator is actuated in order to top up the pressure in the compressed air system of the brake unit.

The predefined second pressure value can be, for example, the operating pressure of the compressed air system of the brake unit under ordinary operating conditions.

The pneumatic brake unit preferably consists of the service brakes of the motor vehicle, which can for example be in the form of wheel brakes.

The pressure in the compressed air system of the brake unit can be sensed by a pressure sensor. For this, the pressure sensor can be fitted into a compressed-air line or a compressed-air reservoir of the compressed air system.

The pressure-generator can be a compressor or concentrator, for example in the form of a reciprocating piston compressor or a membrane compressor. In commercial vehicles so-termed air pressurizers are used, which work in the manner of a compressor. If the pressure-generator is in permanent drive connection with the internal combustion engine of the motor vehicle, then it is not powered during a coasting mode in which the internal combustion engine is switched off, so no pressure is generated during the coasting mode.

If the pressure-generator is not driven during the coasting mode, the pressure level in the compressed air system of the brake unit can fail to an unacceptably low value, for example due to an existing leak in the system.

In that the pressure-generator is actuated in order to top up the pressure in the compressed air system of the brake unit when the predefined minimum value is reached, it can be ensured that in the compressed air system of the brake unit there is always a pressure level high enough for carrying out a forthcoming braking process.

In an advantageous further development it is provided that when the pressure determined reaches or fails below the first predefined pressure value, the internal combustion engine is automatically started and the pressure in the compressed air system of the brake unit is increased, by a pressure-generator driven by the internal combustion engine, to the second pressure value. When the second pressure value has been reached or exceeded and the operating conditions for coasting are still, or are again satisfied, then the internal combustion engine is again stopped and the drive-train is again operated in the coasting mode. So since the coasting mode is only interrupted during the phase of compressed air production, the fuel consumption and the emissions of harmful substances and CO₂ can be kept low.

If the drive-train comprises a pressure-generator independent of the internal combustion engine for increasing the pressure in the compressed air system of the brake unit, then in accordance with an advantageous further development it is provided that when the pressure determined reaches or falls below the predefined, first pressure value, the pressure-generator independent of the internal combustion engine is automatically actuated in order to increase the pressure in the compressed air system of the brake unit.

In this way it can be ensured that in the compressed air system of the brake unit there is always a pressure high enough for carrying out a forthcoming braking process, without having to start the internal combustion engine during the coasting mode. Consequently the fuel consumption and the emissions of harmful substances and CO₂ can be further reduced.

If the drive-train comprises both a pressure-generator that is driven by the internal combustion engine and a pressure-generator that is independent of the internal combustion engine for increasing the pressure in the compressed air system of the brake unit, then it can preferably be provided that the pressure-generator independent of the internal combustion engine is mainly operated when the internal combustion engine is switched off. This allows the pressure-generator independent of the internal combustion engine to be made correspondingly small.

The invention also relates to a control unit designed to carry out the method according to the invention. The control unit comprises means that serve to implement the method according to the invention. These means include hardware means and software means. The hardware means of the control unit are interfaces for the exchange of data with the assemblies of the drive-train that participate in carrying out the method according to the invention. For this, the control unit is also connected to necessary sensors and if needs be also to other control units in order to pick up the decision-relevant data and to issue control commands. For example the control unit can be in the form of a transmission control unit or a brake control unit. The hardware means of the control unit also include a processor for data processing and if appropriate, a memory for data storage. The software means consist of program modules for carrying out the method according to the invention.

The system according to the invention can also be embodied as a computer program product which, when it is running on a processor of a control unit, instructs the processor software to carry out the associated process steps which are the object of the invention. In this connection the object of the invention also includes a computer-readable medium on which the aforesaid computer program product can be stored and recalled.

The invention is not limited to the combination of features indicated in the independent claims or the claims that depend on them. There are in addition possibilities for combining individual features with one another, provided that they emerge from the claims, the description given below, or directly from the FIGURE.

### BRIEF DESCRIPTION OF THE DRAWING

Preferred further developments emerge from the subordinate claims and the following description. An example embodiment of the invention, to which it is not limited is explained in greater detail with reference to the FIGURE. The sole FIGURE shows a schematic representation of a drive-train with a control unit for carrying out the method according to the invention.

### DETAILED DESCRIPTION OF THE PREFERRED EMBODIMENTS

The FIGURE shows a schematic representation of a drive-train 1 of a motor vehicle which is a commercial vehicle such as a truck or a bus. This drive-train 1 comprises a drive aggregate that can be coupled on its drive output side to the drive input side of a transmission by way of an interposed starting clutch 3. On its drive output side the transmission is then connected to other drive output components long known to those familiar with the subject, and to the vehicle wheels of the commercial vehicle.

The drive aggregate of the motor vehicle can be in the form of an internal combustion engine. Besides an internal combustion engine, however, the drive aggregate can also comprise an electric machine and consequently be in the form of a hybrid drive.

The transmission is preferably an automatic or automated transmission in which, to engage gear steps, frictional and/or interlocking shifting elements are closed.

The drive-train I can be opened either by opening the starting clutch 3 or by shifting the transmission to neutral. When the drive-train 1 is open the internal combustion engine is disconnected from the drive output.

The drive-train I is additionally equipped with a compressed air system, of which in this case only a small part is illustrated schematically. The compressed air system comprises a pressure-generator that produces compressed air or pressurized air and makes it available to the compressed air system. In this case the pressure-generator expediently works as a compressor and can be in permanent drive connection with the drive aggregate. The compressed air system also comprises at least one compressed-air reservoir, in which compressed air or pressurized air can be stored. Here, the compressed air system serves to operate a pneumatic brake unit of the drive-train 1.

The brakes of the motor vehicle are in the form of wheel brakes actuated by the compressed air system.

In addition the motor vehicle comprises a control system 2 in which a plurality of different control units are connected to one another by way of a data bus system 5, for example a CAN bus system. Among others, in the data bus system 5 an engine control unit ECU, a transmission control unit TCU and a brake control unit BCU are provided, of which the engine control unit ECU is responsible for controlling the drive aggregate, the transmission control unit TCU for controlling the transmission and—in some circumstances indirectly via a further control unit—also the starting clutch 3, and the brake control unit BCU for controlling the pneumatic brake unit. The transmission control unit TCU can communicate bidirectionally on the one hand with the transmission and on the other hand with the engine control unit ECU and the brake control unit BCU. By way of the data bus system 5 the control units are provided with the data relevant for them. The control units can receiving signals from the sensors, process those signals, and as a function of them emit control or data signals.

Thus, for example, the transmission control unit TCU comprises a processor 6 and storage means 7 for the storage and recall of parameters, signals and information, as well as a computer program product 11 designed in such manner that it can bring about operation of the drive-train in a coasting mode, taking into account a pressure in the compressed air system of the brake unit. In addition the transmission control unit TCU comprises at least one receiver interface 8 designed to receive all the relevant data from the sensors present. the transmission control unit TCU also comprises a data processing device 9 for processing and evaluating the data received or the information in the data received, and a transmitting interface 10 via which corresponding signals can be emitted for the actuation of drive-train components.

The transmission control unit TCU controls the operation of the transmission with reference to driving condition data and data reflecting the wishes of the driver. A shifting strategy stored in the transmission control unit TCU in the form of a computer program determines respective shifting reactions, in particular a gearshift from a current actual gear to a target gear, or a temporary power flow interruption in the drive-train 1.

Besides the road condition determined, the driving condition data used can include the current driving resistance, the current vehicle inclination, the current vehicle mass, the current vehicle speed, the current vehicle acceleration, the current engine torque, the current engine rotational speed and other values. These data can at least in part be supplied by the engine control unit ECU and by suitable sensor devices.

Driver's wish data can for example be signaled by the actuation of an actuation element, or detected by sensors, and sent directly or indirectly to the transmission control unit TCU. The actuation element can for example be in the form of an accelerator pedal or a switch for the manual initiation of the coasting mode.

Data from a navigation device are supplied to the control unit 2. The navigation device provides topographical data about the surroundings of a current position of the motor vehicle and about the surroundings at a defined distance ahead of the current position of the motor vehicle. The location of the current vehicle position can be determined by means of a satellite positioning system such as GPS or GLONASS.

The control units are connected for data exchange with data-transmitting connections 4 to corresponding components of the drive-train 1. The data-transmitting connections 4 between the control units and the drive-train components can for example be in the form of one or more electronic bus systems.

The method according to the invention for operating a drive-train 1 of the motor vehicle now provides that prior to the motor vehicle being operated in the coasting mode, various operating conditions are checked, which must be satisfied in order to authorize the internal combustion engine to be switched off.

If the operating conditions for the coasting mode are satisfied but the pressure in the compressed air system of the brake unit is lower than a predefined first pressure value, then the switching off of the internal combustion engine in order to produce the coasting mode can be temporarily prevented until the pressure in the compressed air system of the brake unit has been increased by the pressure-generator to a predefined second pressure value.

If the drive-train 1 is then operated in a coasting mode, the pressure in the compressed air system of the brake unit is determined continuously and compared with the predefined first pressure value, and if the pressure determined reaches or fails below the predefined first pressure value, the pressure in the compressed air system of the brake unit is automatically increased by the pressure-generator to the predefined second pressure value.

The switching off of the internal combustion engine in the context of a coasting mode can be carried out or prevented by the transmission control unit TCU. Thus, the pressure signal from the pressure sensor in the compressed air system can be sensed directly by the transmission control unit TCU or by the brake control unit BCU, and in the latter case the brake control unit BCU then transmits a corresponding pressure signal to the transmission control unit ICU. Taking account inter alia of the sensed pressure signal or that received by the brake control unit BCU, the transmission control unit TCU then initiates the switching off of the internal combustion engine in order to produce the coasting mode. For this, the transmission control unit TCU can send a corresponding signal to the engine control unit ECU, which thereupon switches off the internal combustion engine.

Alternatively, in the context of the coasting mode the switching off of the internal combustion engine can also be carried out or prevented by the brake control unit BCU. Thus, the brake control unit BCU can evaluate the pressure signal sensed in the compressed air system by the pressure sensor. The brake control unit BCU then also receives from the transmission control unit TCU the further data about the defined operating conditions that must be satisfied during driving for the drive-train 1 to be opened and for the internal combustion engine to be switched off, or a signal that indicates whether the operating conditions required for the coasting mode are satisfied. If the conditions for the coasting mode are satisfied, then the brake control unit BCU sends a corresponding signal to the transmission control unit TCU, whereupon the transmission control unit TCU opens the drive-train 1 and the engine control unit ECU switches off the internal combustion engine.

The control unit, which in the context of the coasting mode triggers or prevents the switching off of the internal combustion engine, is preferably designed such that it can receive signals from the pressure sensor in the brake unit and evaluate them correspondingly.

### Indexes

1 Drive-train

2 Control system

3 Starting clutch

4 Connection

5 Data bus system

6 Processor

7 Storage means

8 Receiving interface

9 Data processing device

10 Transmitting interlace

11 Computer program product

ECU Engine control unit

TCU Transmission control unit

BCU Brake control unit

1-10. (canceled)

11. A method for operating a drive-train (1) of a motor vehicle having an internal combustion engine, a transmission connected between the internal combustion engine and a drive output, and a compressed air system of a brake unit, the method comprising:
operating the drive-train (1) in a coasting, mode, while the motor vehicle is traveling, during which the drive-train (1) is disengaged and the internal combustion engine is turned off;
determining a pressure in a compressed air system of the brake unit, when a manual command is issued or a defined operating conditions exist during operation of the drive-train in the coasting mode; and
if the determined pressure reaches or falls below a predefined first pressure value, automatically increasing the pressure in the compressed air system of the brake unit, via a pressure-generator, to a predefined second pressure value.

12. The method according to claim 11, further comprising if the determined pressure reaches or falls below the predefined first pressure value, automatically starting the internal combustion engine and increasing the pressure in the compressed air system of the brake unit, by a pressure-generator driven by the internal combustion engine, up to the predefined second pressure value, and
again turning off the internal combustion engine when the second pressure value is either reached or exceeded and the operating conditions for the coasting mode are satisfied.

13. The method according to claim 11, further comprising automatically actuating a pressure-generator, independent of the internal combustion engine, to increase the pressure in the compressed air system of the brake unit, if the determined pressure either reaches or falls below the predefined first pressure value.

14. The method according to claim 11, further comprising, during the coasting mode, either initiating or preventing the turning off of the internal combustion engine by either a brake control unit (BCU) or a transmission control unit (TCU).

15. The method according to claim 11, further comprising determining the pressure in the compressed air system of the brake unit by a brake control unit (BCU) and emitting a signal to a second control unit (TCU) from the brake control unit (BCU), whereby, taking account of the signal from the brake control unit (BCU), initiating or preventing with the second control unit (TCU) from turning off the internal combustion engine for purposes of the coasting mode.

16. The method according to claim 14, further comprising evaluating signals from a sensor with the brake or the transmission control unit (BCU, TCU), that initiates or prevents the turning off of the internal combustion engine during the coasting mode, for determining the pressure in the compressed air system of the brake unit.

17. The method according to claim 11, further comprising temporarily preventing the turning off of the internal combustion engine in order to produce the coasting mode, when the operating conditions for the coasting mode are satisfied but the pressure in the compressed air system of the brake unit is lower than the predefined first pressure value, until the pressure in the compressed air system of the brake unit reaches the predefined second pressure value.

18. A control unit (BCU, TCU) for operating a drive-train (1) of a motor vehicle for carrying out the method according to claim 11.

19. A computer program product with program code means stored on a computer-readable data carrier for carrying out the method according to claim 11 when the computer program product is either run on a computer or a corresponding computer unit of a control unit (BCU, TCU) of the drive train.

20. A drive-train (1) of a motor vehicle comprising:
a control unit (BCU, TCU) having a computer which runs a computer program product having program code stored on a computer-readable data carrier to carry out a method for operating the drive-train (1) of the motor vehicle,
the drive train having an internal combustion engine,
a transmission connected between the internal combustion engine and a drive output of the drive-train (1),
a compressed air system for operating the brake unit of the drive-train (1), and
a pressure-generator, independent of the internal combustion engine, for increasing the pressure in the compressed air system of the brake unit so that, while the motor vehicle is traveling, the drive-train (1) is operated in a coasting mode during which the drive-train (1) is disengaged and the internal combustion engine is turned off;
a pressure, in the compressed air system of the brake unit, being determined, when a manual command is issued or defined operating conditions exist during operation of the drive-train in the coasting mode; and
if the pressure determined reaches or falls below a predefined first pressure value, the compressed air system of the brake unit automatically increases, via the pressure-generator, the pressure to a predefined second pressure value.
